(19) United States
(12) Patent Application Publication
(10) Pub. No.: US 2005/0076381 A1
(43) Pub. Date: Apr. 7, 2005

(54) Electronic monitoring of activities performed at a cable television tap

(76) Inventor: Donny Gross, (US)

Correspondence Address: SWIDLER BERLIN SHEREFF FRIEDMAN, LLP, 3000 K STREET, NW, BOX IP, WASHINGTON, DC, 20007, US

(21) Appl. No.: 10/677,295

(22) Filed: Oct. 3, 2003

(51) Int. Cl. H04N 7/173; H04N 17/02; H04N 17/00

(52) U.S. Cl. 725/107; 348/192

(57) ABSTRACT

A system for monitoring activities performed at a cable television tap includes a card reader operable to read card data. A controller is coupled to the card reader and operable to determine that card data is read including technician information. A memory is operable to store the card data in association with a first access time data and date data. A remote system is operable to download the stored data, wherein the downloaded data is associated with the cable television tap.

### BACKGROUND OF THE INVENTION

1. Field of the Invention

The present invention relates to a method, a system and computer program product for Cable Television Directional Couplers (“taps”). More particularly, the present invention relates to a method, a system and a computer program product for electronically monitoring activities performed at a Cable Television tap.

2. Description of the Prior Art

Generally, Cable Television (“CATV”) system includes headend equipment that transmits cable programming signals and other information to authorized cable customer equipment. Cable Television taps are provided at positions along the system to allow the cable programming signal and the other information to be split among the authorized cable customer equipment. Typically, these cable television taps include a single input port for receiving the cable programming signal and the other information transmitted from the headend equipment, and a number of outgoing subscriber ports for separating the cable programming signal and the other information. An outgoing subscriber port must be enabled to allow cable customer equipment to receive the cable programming signal and disabled when the cable customer equipment is to no longer receive the cable programming signal.

A service technician is typically contracted to disable and enable the outgoing subscriber ports of cable television taps. The failure of a service technician to disable an outgoing subscriber port of a cable television tap can result in the theft of the cable programming signal and other information from the outgoing subscriber port. In these instances, the theft of the cable programming signal and the other information can continue unless an audit is performed on the cable television tap.

Audit companies are contracted to visit cable television taps and perform a local audit of the cable television taps. An audit typically includes an auditor physically comparing the status of an outgoing subscriber port to a list indicating what the status of the outgoing subscriber port should be. This process is a time consuming and expensive one. An outgoing subscriber port can be enabled for a significant amount of time before it is determined that it should be disabled. Additionally, there is no mechanism for determining what service technician was responsible for disabling the outgoing subscriber port, but did not disable it. Moreover, there is also no way of determining whether the subscriber port was re-enabled by an unauthorized third party after a service technician disabled the outgoing subscriber port.

There is a need for an automated method of monitoring activities performed at a cable television tap. There is a also a need for monitoring of activities performed at the cable television tap to compare the status of an outgoing subscriber port to a list indicating what the status of the outgoing subscriber port should be. There is a further need for monitoring of activities performed at the cable telephone tap to determine, within a specified period of time, that an outgoing subscriber port is still enabled when it should be disabled. There is still a further need for monitoring of activities performed at the cable television tap to determine what service technician was responsible for performing an activity at an outgoing subscriber port. There is still a further need for the monitoring of activities performed at the cable television tap to determine whether a cable television tap was accessed without authorization.

### SUMMARY OF THE INVENTION

According to embodiments of the present invention, a method, a framework, and a computer program product for monitoring the activities performed at a cable television tap are provided. The method records each instance that a cable television tap is accessed. The method can emit a signal including, but not limited to, a wireless signal indicating that a cable television tap has been accessed. The method records cable tap service information including, but not limited to, the service technician performing a service activity at a cable television tap, the company the service technician is employed by, the time and date the service technician performed the service activity, and the actually service activity performed. This information can be recorded over a period of time and then downloaded to one or more business entities. These business entities can compare the activities performed at a cable television tap to a master list specifying the service activities authorized for that cable television tap to determine unauthorized service activities as well as service activities that were authorized, but not performed.

According to an embodiment of the present invention, a method of monitoring the activities performed at a cable television tap is provided. The method includes determining that card data is read including technician information and storing the card data in association with a first access time data and date data. The stored data is downloaded to a remote location, wherein the downloaded data is associated with the cable television tap.

According to an embodiment of the present invention, a computer program product for monitoring the activities performed at a cable television tap is provided. The computer program product includes a computer readable medium and computer program instructions, executable by a processor, stored on the computer readable medium. The instruction are operable to determine that card data is read including technician information, store the card data in association with a first access time data and date data, and download the stored data to a remote location. The downloaded data is associated with the cable television tap.

According to an embodiment of the present invention, a system for monitoring the activities performed at a cable television tap is provided. The system includes a card reader operable to read card data. The system also includes a controller, coupled to the card reader, operable to determine that card data is read including technician information. A memory is coupled to the controller and operable to store the card data in association with a first access time data and date data. A remote system is operable to download the stored data. The downloaded data is associated with the cable television tap.

### BRIEF DESCRIPTION OF THE DRAWINGS

The above described features and advantages of the present invention will be more fully appreciated with reference to the detailed description and appended figures in which:

FIG. 1 depicts a functional block diagram of a cable television framework in which the present invention can find application according to an exemplary embodiment of the present invention;

FIG. 2 depicts a block diagram of a cable television tap in the cable television framework of FIG. 1 according to an exemplary embodiment of the present invention;

FIG. 3 depicts is a side view of a cable television tap of FIG. 2 according to an exemplary embodiment of the present invention; and

FIG. 4 is a flow diagram for a method of monitoring activities performed at a cable television tap.

### DETAILED DESCRIPTION OF THE INVENTION

The present invention is now described more fully hereinafter with reference to the accompanying drawings that show exemplary embodiments of the present invention. The present invention, however, may be embodied in many different forms and should not be construed as limited to the exemplary embodiments set forth herein. Appropriately, these embodiments are provided so that this disclosure will be thorough, complete, and will fully convey the scope of the present invention.

According to embodiments of the present invention, a method, a framework, and a computer program product for monitoring the activities performed at a cable television tap are provided. The method records each instance that a cable television tap is accessed. The method can emit a signal including, but not limited to, a wireless signal indicating that a cable television tap has been accessed. The method records cable tap service information including, but not limited to, the service technician performing a service activity at a cable television tap, the company the service technician is employed by, the time and date the service technician performed the service activity, and the actual service activity performed. This information can be recorded over a period of time and then downloaded to one or more business entities. These business entities can compare the activities performed at a cable television tap to a master list specifying the service activities authorized for that Cable Television tap to determine unauthorized service activities as well as service activities that were authorized, but not performed.

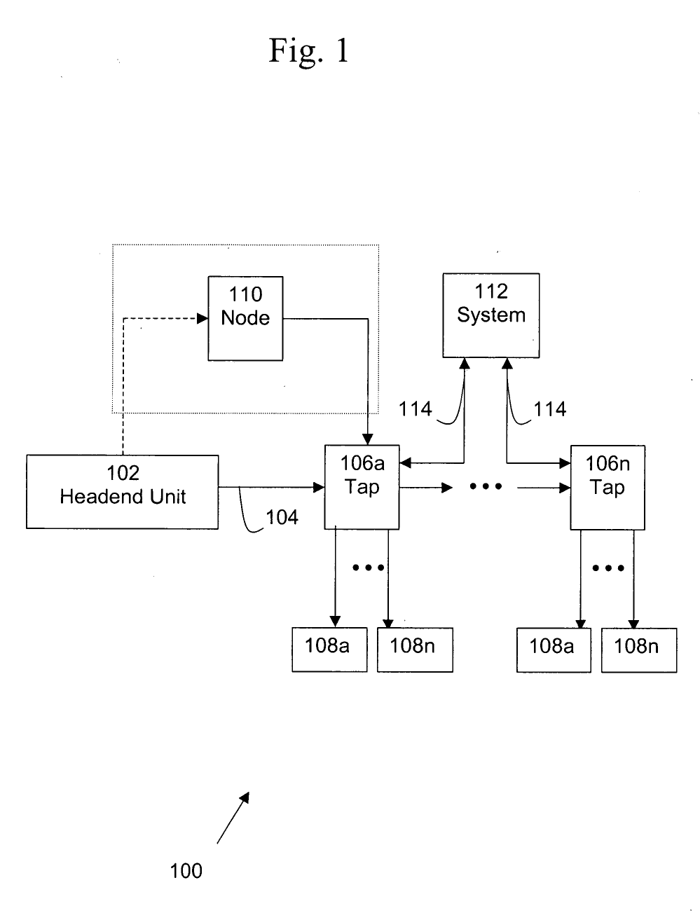

An exemplary functional block diagram of a Cable Television (“CATV”) Framework in which the present invention can find application according to an embodiment of the present invention is shown in FIG. 1. In the embodiment of FIG. 1, Framework 100 can be implemented to provide CATV services to subscribers throughout a geographic region. In the FIG. 1 embodiment, Framework 100 includes, but is not limited to, a headend unit 102, communication medium 104, Cable Television taps 106a-106n, subscriber equipment 108a-108n, system 112 and communication medium 114. In the FIG. 1 embodiment, subscriber equipment 108 can include, but is not limited to, set top units, computers, telephones and televisions.

In the embodiment of FIG. 1, headend unit 102 receives a satellite television signal, demodulates the satellite television signal to a baseband signal and transmits the baseband signal over communication medium 104 to Cable Television taps 106a-106n. The baseband signal includes, but is not limited to, a radio frequency (RF) signal and an optical signal. The communication medium 104 includes, but is not limited to, a coaxial cable and a fiber optic cable. In the FIG. 1 embodiment, Cable Television taps 106 receive a RF signal and route the RF signal to a subscriber by employing an outgoing subscriber port. In an embodiment of FIG. 1, optical signals are transmitted by headend unit 102, fiber optic cable is employed as the communication medium 104, and one or more nodes 110 are included in Framework 100 for converting the optical signal to a RF signal for receipt by cable television taps 106. Nodes 110 can include a power supply (not shown) for generating an AC power signal that is also transmitted throughout the CATV Framework 100, in which case the baseband signal includes an information signal component and an AC power signal component.

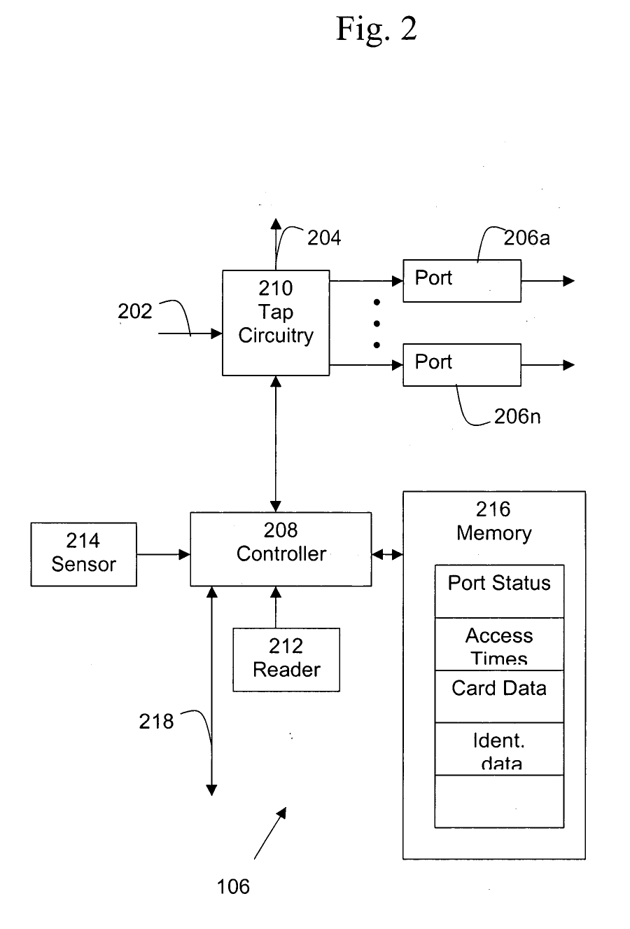

In the embodiment of FIG. 2, system 112 is a general purpose computer, such as a workstation, personal computer, server or the like, but can be any apparatus that executes program instructions in accordance with the present invention. System 112 includes a processor (CPU) (not shown) connected by a bus (not shown) to memory (not shown), network interface (not shown) and I/O circuitry (not shown). System 112 receives cable tap service information from taps 106 over communications medium 114, stores the cable tap service information, and generates reports employing the cable tap service information. These reports can be used for determining unauthorized service activities as well as service activities that were authorized, but not performed. In an embodiment of the invention this cable tap service information can be forwarded to other systems (not shown) like system 112. In the embodiment of FIG. 1, communications medium 114 includes, but is not limited to, wired lines and air. As will be appreciated by those skilled in the art, communications medium 114 can be any medium which data can be transmitted over.

An exemplary block diagram of a cable television tap 106 in the CATV Framework 100 of FIG. 1 is shown in FIG. 2. In the embodiment of FIG. 2, cable television tap 106 is provided within the CATV Framework 100 for routing the RF signal to subscriber equipment 108. In the embodiment of FIG. 2, cable television tap 106 includes an incoming port 202, a main outgoing port 204, outgoing subscriber ports 206a-206n, a controller 208, a tap circuitry 210, a reader 212, a sensor 214, a memory 216 and a download port 218. The incoming port 202 receives a RF signal from communication medium 104 and transmits the RF signal to outgoing subscriber ports 206a-206n. The main outgoing port 204 routes the RF signal to other cable television taps 106 within the CATV Framework 100. The outgoing subscriber ports 206 can route the RF signal to subscriber equipment 108. The outgoing subscriber ports 206 can be enabled in order to route the RF signal to subscriber equipment 108 and each cable television tap 106 can include various numbers of outgoing subscriber ports. For example, cable television tap 106 can include 2, 4, 8 or 16 outgoing subscriber ports 206.

In the embodiment of FIG. 2, the tap circuitry 210 processes the RF signal received by the Cable Television tap 106 to provide an outgoing RF signal to enabled ones of outgoing subscriber ports 206. The tap circuitry 210 can also provide feedback signals specifying a status of each subscriber port 206a-206n including, but not limited to, enabled and disabled. In the embodiment of FIG. 2, the controller 208 is coupled to tap circuitry 210 and processes commands provided by the reader 212, the sensor 214, and the tap circuitry 210 employing signals and transmits cable tap service information to system 112 from download port 218. In the FIG. 2 embodiment, download port 218 can couple to telephone lines and a wireless transmitter.

In the embodiment of FIG. 2, the reader 212 couples to the controller 208 and is operative to cause card data to be read from a technician's card input by a service technician and sends the card data to the controller 208 for storage. Card data includes, but is not limited to, technician identification information and technician company identification information. In an embodiment of the invention, the card stores the card data read by the reader 212 on a magnetic strip or the like. In an embodiment, the reader is a radio frequency identification reader that can receive a unique ID code transmitted wirelessly from a technician's Radio Frequency identification (RFID) tag and sends the unique ID code to the controller 208 for storage. RFID can be a microchip that listens for a RF query and responds by transmitting a unique ID code. The reader can include a transceiver for transmitting and receiving RF signals.

In the embodiment of FIG. 2, sensor 214 couples to controller 208 and indicates to the controller when the cable television tap 106 is accessed so that the controller may store the time of access. For example, there may be a door or other covering over the subscriber ports 206 that has a closed and an opened position. In the embodiment of FIG. 2, sensor 214 and reader can be powered by a power supply including, but not limited to, the AC component of the broadband signal provided to tap 106 and local power source.

In the embodiment of FIG. 2, memory 216 couples to controller 208 and is operable to store data including, but not limited to, tap and outgoing subscriber port identification data, outgoing subscriber port status data, access time and date data and card data. Data stored in memory 216 can be associated with one another. For example, when sensor 214 is triggered, the time and date the sensor was triggered can be stored. Additionally, if the card reader reads -card data, the card data can be associated with an access time and date as well as port status information. Data stored in memory 216 can be downloaded upon request and at a specified time period to system 212. The download can be performed using wireless technology such as with transceivers included in television taps and at system 212.

Outgoing subscriber port status data can be stored in response to enablement or disablement of an outgoing subscriber port, as well as re-enablement by an unauthorized third party. In the FIG. 2 embodiment, Tap circuitry 210 provides feedback to the controller 208 to set the status information corresponding to the enablement of disablement of outgoing subscriber port to indicate its updated status in the memory 216. Tap on identification data uniquely identifies a tap 106 within CATV Framework 100. Outgoing subscriber port identification data identifies an outgoing subscriber port in a tap 106. Tap and outgoing subscriber port identification data can be associated with port status data to enable the status of outgoing subscriber ports within a tap to be accurately recognized. The association of data in memory 216 to one another conveniently permits the determination of tap activity for a Cable Television tap 106. As a result, time consuming local auditing of taps 106 to determine the status of outgoing subscriber ports of a tap 106 can be avoided altogether, thus saving time and money for cable television companies. Additionally, unauthorized service can be identified within a reduced time period.

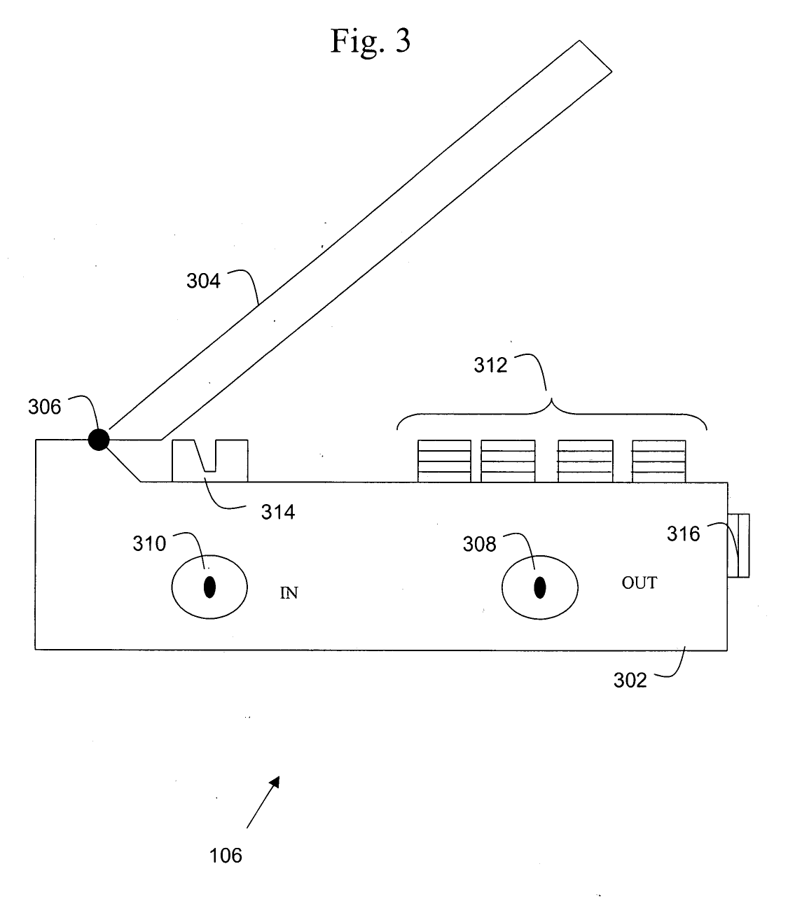

An exemplary side view of a cable television tap 106 of FIG. 2 according to an embodiment of the present invention is shown in FIG. 3. In the embodiment of FIG. 3, cable television tap 106 includes a body portion 302, a cover portion 304, hinge/sensor portion 306, an outgoing port 308, an incoming port 310, outgoing subscriber ports 312, a reader 314 and download port 316. The body portion 302 protects circuitry of tap 102, such as the controller, tap circuitry and memory, from damage by elements, such as rain and wind. The cover portion 304 protects reader 314 from damage by elements. The hinge sensor 306 rotates the cover portion 304 between an open and closed position as well as provides an indication of whether the cover is closed and open.

Incoming port 310 receives a RF signal and transmits the RF signal to outgoing subscriber ports 312. Outgoing port 308 routes the RF signal to other cable television taps 106 within the CATV Framework 100. Outgoing subscriber ports 312 can route the RF signal to subscriber equipment. Outgoing subscriber ports 312 can be enabled in order to route the RF signal to subscriber equipment. Card reader 314 reads card data from a technician card input by a service technician for storage. The download port provides the interface for downloading stored information to a remote system, such as system 112.

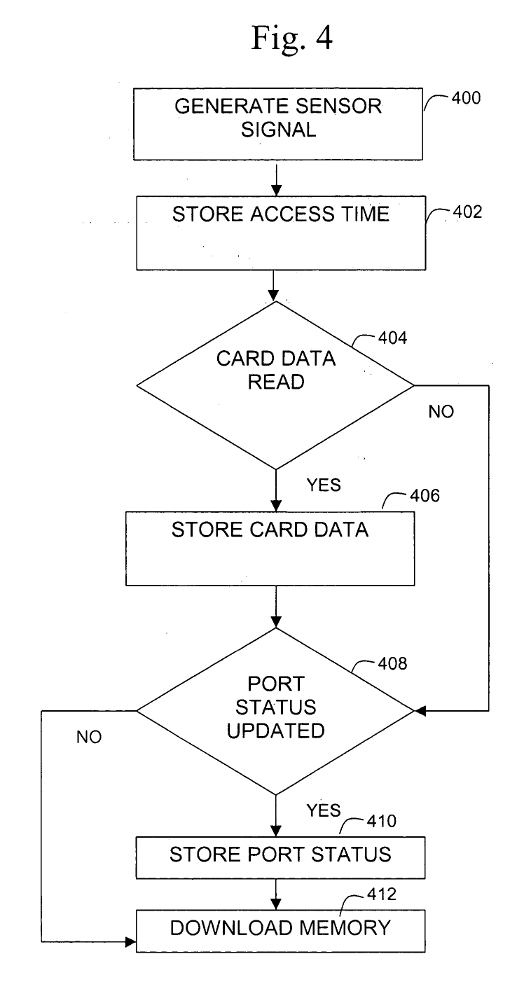

An exemplary flow diagram for a method of monitoring activities performed at a cable television tap is shown in FIG. 4. As shown in FIG. 4, the process begins with step 400, in which a sensor signal is generated. The sensor signal can be generated in response to an individual accessing a cable television tap. In step 402, the time that the sensor signal was generated is stored in memory. In step 404, it is determined whether card data is read. If card data is read, the method proceeds to step 406. In step 406, the card data that was read is stored in memory. The card data that is read can be associated with an access time and date. If the card data is not read, the method proceeds to step 408. In step 408, it is determined whether the port status has been updated. The port status can be updated when a port has been enabled or disabled. The enabling and disabling of a port triggers feedback that specifies that the status of a port has been updated, and what the updated status is. If the port status has been updated, the method proceeds to step 410. In step 410, the updated port status is stored in memory. The updated port status can be associated with an access time and card data. If the port status has not been updated, the method proceeds to step 412. In step 412, the data stored in memory can be downloaded to a remote system. The data can be downloaded upon request from remote system as well as at a specified time interval.

While specific embodiments of the present invention have been illustrated and described, it will be understood by those having ordinary skill in the art that changes can be made to those embodiments without departing from the spirit and scope of the invention.

1. A method of monitoring activities performed at a cable television tap, the method comprising the steps of:
determining whether technician data is read;
storing the technician data in association with an access time and an access date upon determining that the technician data is read; and
providing data to a remote location;
associating the data with the cable television tap.

2. The method according to claim 1, further comprising: generating a sensor signal.

3. The method according to claim 2, further comprising storing the access time and the access date in response to the sensor signal.

4. The method according to claim 1, further comprising: determining whether a port status has been modified.

5. The method according to claim 4, further comprising storing the modified port status in association with the access time and access date upon determining that the port status has been modified.

6. The method according to claim 1, wherein the data is provided at a predetermined time interval.

7. The method according to claim 1, wherein the data is provided upon request.

8. The method according to claim 1, further comprising: receiving the data at a computer at the remote location.

9. The method according to claim 1, further comprising generating a report base in part on the provided data.

10. The method according to claim 1, further comprising reading technician data.

11. The method according to claim 1, further comprising providing port status data.

12. A system for monitoring activities performed at a cable television tap, the system comprising the steps of:
a controller operable to determine whether technician data is read;
a memory, coupled to controller, operable to store the technician data in association with an access time and an access date upon a determination that the technician data is read;
a communication medium, coupled to controller, operable to provide data to a remote location; and
the controller operable to associate the data with the cable television tap.

13. The system according to claim 12, further comprising: a sensor, coupled to the controller, operable to generate a sensor.

14. The system according to claim 13, further comprising the memory operable to store the access time and the access date.

15. The system according to claim 12, further comprising: the controller operable to determine whether a port status has been modified.

16. The system according to claim 6, further comprising the memory operable to store the modified port status in association with the access time and access date upon a determination that the port status has been modified.

17. The system-according to claim 12, wherein the data is provided at a predetermined time interval.

18. The system according to claim 12, wherein the data is provided upon request.

19. The system according to claim 12, further comprising: a computer, coupled to the communication medium, operable to receive the data.

20. The system according to claim 12, further comprising the computer operable to generate a report base in part on the provided data.

21. The system according to claim 12, further comprising a reader, coupled to the controller, operable to read technician data.

22. The system according to claim 12, further comprising tap circuitry, coupled to the controller, operable to providing port status data.
